(19) United States
(12) Patent Application Publication
(10) Pub. No.: US 2013/0148338 A1
(43) Pub. Date: Jun. 13, 2013

(54) LIGHT EMITTING DIODE TABLE LAMP

(71) Applicants: TE-SHENG CHEN, Chu-Nan (TW); SUNG-HSIANG YANG, Chu-Nan (TW)

(72) Inventors: TE-SHENG CHEN, Chu-Nan (TW); SUNG-HSIANG YANG, Chu-Nan (TW)

(73) Assignee: FOXSEMICON INTEGRATED TECHNOLOGY, INC., Chu-Nan (TW)

(21) Appl. No.: 13/313,000

(22) Filed: Dec. 7, 2011

(51) Int. Cl. F21L 4/08; F21V 21/002; F21V 21/28; F21V 21/00

(52) U.S. Cl. 362/183

(57) ABSTRACT

An exemplary LED table lamp includes a lamp stand and an LED lighting module. The LED lighting module includes a light source, a power storage device and a first electrical connector. The LED lighting module can be independently used as a torch. The lamp stand includes a second electrical connector. The second electrical connector can be connected to an external electrical power supply. The first electrical connector can be detachedly electrically connected to the second electrical connector. The power storage device can be electrically connected to the light source to supply electrical power to the light source. The light source can be electrically connected to the second electrical connector, so that the external electrical power supply can supply electrical power to the light source.

### BACKGROUND

1. Technical Field

The present disclosure relates to a light emitting diode (LED) table lamp, and particularly to an LED table lamp having a detachable LED lighting module.

2. Description of Related Art

A conventional table lamp has a single function and can only provide illumination for a single application occasion (i.e., providing illumination for working on a table most of which is either reading or writing), but cannot be used in different application occasions according to requirements.

It is thus desirable to provide a table lamp which can overcome the limitations described.

### BRIEF DESCRIPTION OF THE DRAWINGS

FIG. 1 is a perspective view of an LED table lamp in accordance with an exemplary embodiment of the present disclosure.

FIG. 2 is an exploded view of the LED table lamp of FIG. 1.

FIG. 3 is an exploded view of the LED table lamp of FIG. 1, from another aspect.

### DETAILED DESCRIPTION

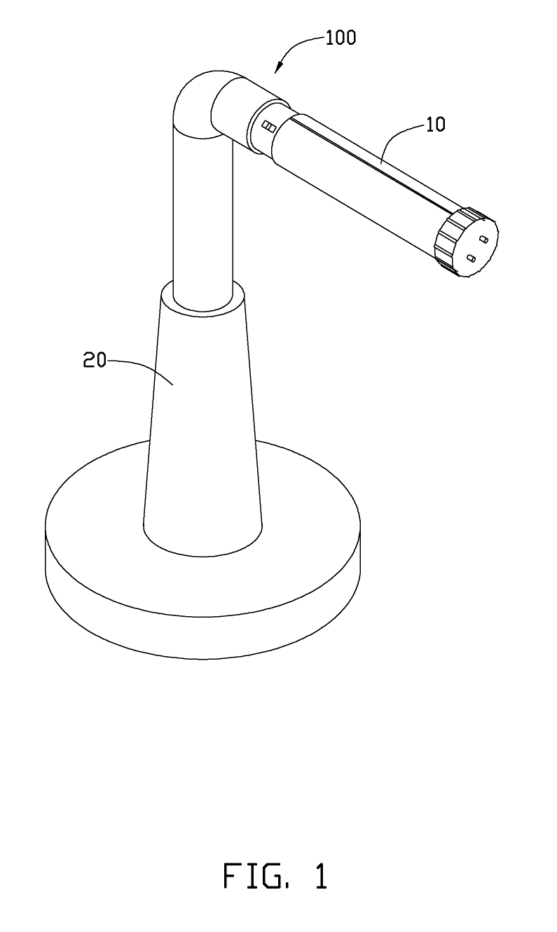

Referring to FIG. 1, an LED table lamp 100 according to an exemplary embodiment of the present disclosure includes an LED lighting module 10 and a lamp stand 20.

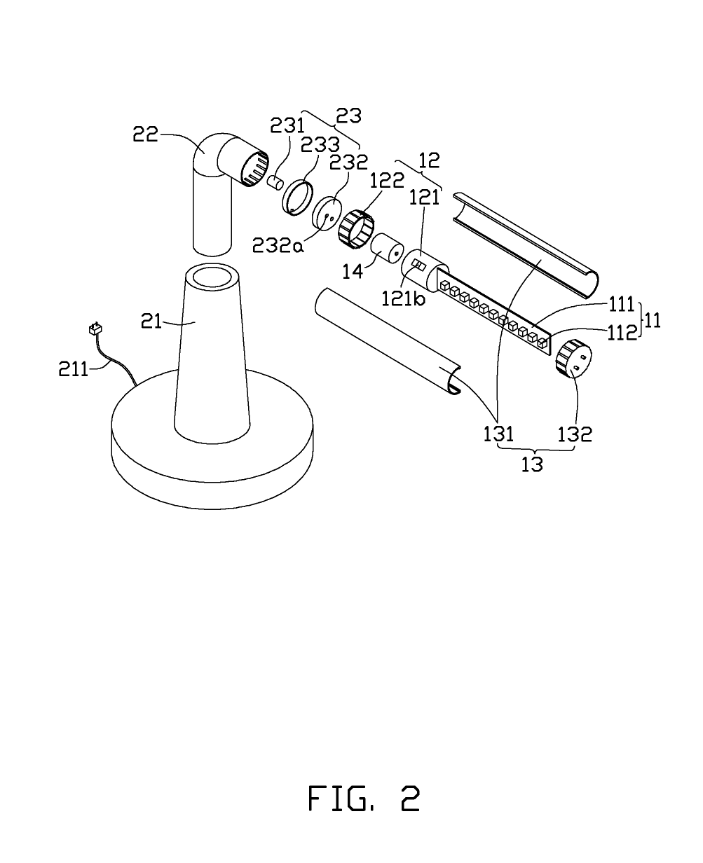

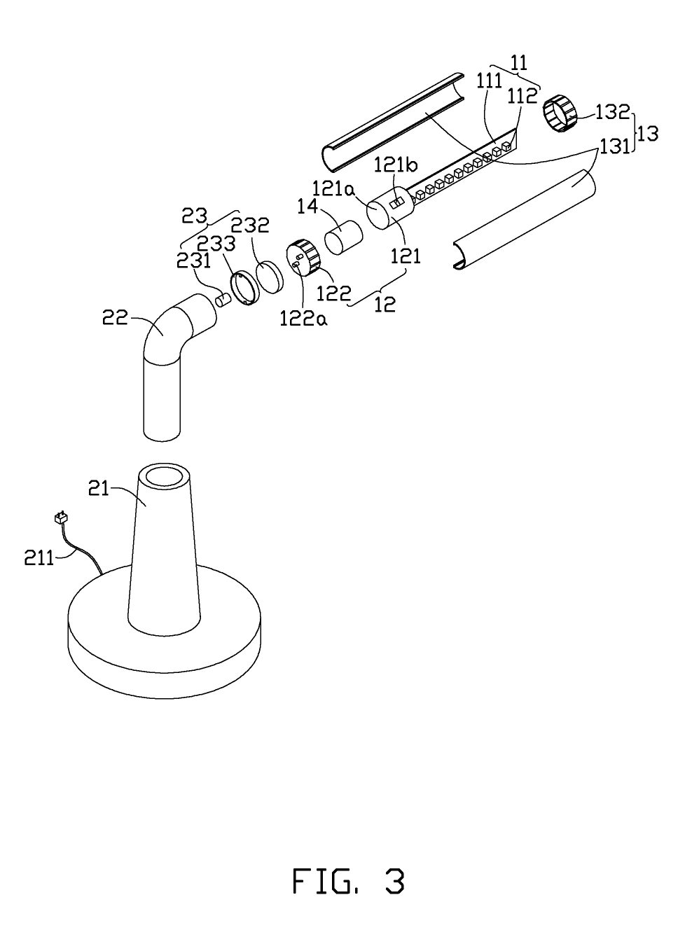

Also referring to FIGS. 2-3, the LED lighting module 10 includes a light source 11, a holder 12, a casing 13, and a power storage device 14.

The light source 11 includes a printed circuit board 111 and a plurality of light emitting diodes (LEDs) 112 arranged on the printed circuit board 111.

The holder 12 includes a cylindrical body 121 and a cylindrical first electrical connector 122. The body 121 has one end connected to the light source 11, and another end defining a receiving chamber 121a for receiving the power storage device 14 therein. The first electrical connector 122 covers the end of the body 121 with the receiving chamber 121a, thereby sealing the power storage device 14 in the body 121. Two inserting pins 122a extend out from the first electrical connector 122 along a direction away from the body 121.

An electrical switch 121b is provided on an outer circumferential face of the body 121. The electrical switch 121b can be moved relative to the body 121 among a first position, a second position, a third position, and a fourth position. When the electrical switch 121b is moved to the first position, the electrical switch 121b electrically interconnects the power storage device 14 and the inserting pins 122a. When the electrical switch 121b is moved to the second position, the electrical switch 121b electrically interconnects the power storage device 14 and the light source 11. When the electrical switch 121b is moved to the third position, the electrical switch 121b electrically interconnects the light source 11 and the inserting pins 122a. When the electrical switch 121b is moved to the fourth position, the electrical switch 121b electrically interconnects the light source 11, the power storage device 14 and the inserting pins 122a.

The casing 13 includes a cylindrical lamp envelope 131 and a cover 132. The lamp envelope 131 is made of a light-permeable material, such as transparent or translucent plastic. The lamp envelope 131 includes two symmetrical parts assembled together. Each of the parts has a semicircular cross section. One end of the lamp envelope 131 connects the body 121, another end of the lamp envelope 131 is sealed by the cover 132. The light source 11 is received in the lamp envelope 131, and light generated by the light source 11 can transmit through the lamp envelope 131 for illumination.

The power storage device 14 is a rechargeable battery, which can be charged and then discharged to provide electrical power for the light source 11.

The lamp stand 20 includes a supporting seat 21, a connecting portion 22 and an inserting module 23. An electrical wire 211 with a plug extends from a bottom of the supporting seat 21 for electrically connecting with an external electrical power supply via a power socket (not shown). The electrical wire 211 electrically connects with the inserting module 23.

The connecting portion 22 includes two ends perpendicular to each other. The two ends of the connecting portion 22 are respectively pivotedly connected to the supporting seat 21 and the inserting module 23. Thus, the connecting portion 22 can rotate relative to the supporting seat 21 to regulate illumination direction of the LED lighting module 10, and the inserting module 23 and the LED lighting module 10 can rotate relative to the connecting portion 22 to regulate illumination angle of the LED lighting module 10.

The inserting module 23 includes a first electrode 231, an annular second electrode 233 and a circular second electrical connector 232. The second electrode 233 is sleeved on an outer circumference of the second electrical connector 232. The first electrode 231 is connected to a side face of the second electrical connector 232. Two inserting holes 232a are defined in another opposite side face of the second electrical connector 232. The inserting pins 122a of the first electrical connector 122 are correspondingly inserted into the inserting holes 232a of the second electrical connector 232 and electrically connect with the first and second electrodes 231, 233, so that the LED lighting module 10 can electrically connect with the electrical wire 211 of the lamp stand 20.

When the electrical wire 211 of the supporting seat 21 electrically connects the external electrical power supply and the electrical switch 121b is moved to the first position, the external electrical power supply provides electrical power to the power storage device 14, and the power storage device 14 is charged.

When the electrical wire 211 of the supporting seat 21 electrically connects the external electrical power supply and the electrical switch 121b is moved to the third position, the external electrical power supply provides electrical power to the light source 11, and the light source 11 is turned on to emit light.

When the electrical wire 211 of the supporting seat 21 electrically connects the external electrical power supply and the electrical switch 121b is moved to the fourth position, the external electrical power supply provides electrical power to both the power storage device 14 and the light source 11, and the light source 11 is turned on and the power storage device 14 is charged at the same time.

After the power storage device 14 is completely charged, and the electrical switch 121b is moved to the second position, the power storage device 14 is discharged to turn on the light source 11.

After the power storage device 14 is completely charged, the LED lighting module 10 can be detached from the lamp stand 20 by pulling the first electrical connector 122 apart from the second electrical connector 232, and the LED lighting module 10 can be independently used as an electric torch. Thus, the LED table lamp 100 in the present invention can function as a table lamp or an electric torch, and can be used in different application occasions according to different requirements.

It is to be understood, however, that even though numerous characteristics and advantages of the disclosure have been set forth in the foregoing description, together with details of the structure and function of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A light emitting diode (LED) table lamp, comprising:
an LED lighting module comprising a light source, a power storage device and a first electrical connector;
a lamp stand comprising a second electrical connector configured for electrically connecting with an external electrical power supply, the second electrical connector being electrically connected to the first electrical connector; and
a switch;
wherein the switch is movable between at least two positions, at a first position the light source being electrically connected to the power storage device via the switch, and at a second position the light source being electrically connected to the first electrical connector via the switch; and
wherein the first electrical connector is detachably connected to the second electrical connector whereby the LED lighting module is separable from the lamp stand as an independent lighting device.

2. The LED table lamp of claim 1, wherein the light source comprises a printed circuit board and a plurality of LEDs mounted on the printed circuit board.

3. The LED table lamp of claim 1, wherein the power storage device is a rechargeable battery.

4. The LED table lamp of claim 1, wherein two inserting pins extend from the first electrical connector, two inserting holes being defined in the second electrical connector, the inserting pins of the first electrical connector being correspondingly inserted into the inserting holes of the second electrical connector to electrically connect the LED lighting module and the lamp stand.

5. The LED table lamp of claim 1, wherein the lamp stand further comprises a supporting seat and a connecting portion, the connecting portion interconnecting the supporting seat and the second electrical connector, the connecting portion pivotably connecting the supporting seat and being rotatable relative to the supporting seat to regulate illumination direction of the LED lighting module.

6. The LED table lamp of claim 5, wherein the second electrical connector pivotably connects with the connecting portion, so that the LED lighting module can rotate relative to the connecting portion to regulate illumination angle of the LED lighting module.

7. The LED table lamp of claim 1, wherein the LED lighting module further comprises a body, the body interconnecting the light source and the first electrical connector, the body defining a receiving chamber in an end thereof, the power storage device being received in the receiving chamber.

8. The LED table lamp of claim 7, wherein the LED lighting module further comprises a casing, the casing comprising a lamp envelope and a cover, one end of the lamp envelope connecting the body, another opposite end of the lamp envelope connecting the cover, the light source being received in the lamp envelope.

9. The LED table lamp of claim 8, wherein the lamp envelope is made of a light-permeable material.

10. The LED table lamp of claim 8, wherein the lamp envelope comprises two parts assembled together, each of the two parts having a semicircular cross section.

11. The LED table lamp of claim 7, wherein the switch is provided on the body, the switch being movable relative to the body between the at least two positions.

12. The LED table lamp of claim 11, wherein the power storage device is a rechargeable battery, the electrical switch being further movable to a third position to electrically interconnecting the power storage device and the first electrical connector for charging the power storage device.

13. The LED table lamp of claim 12, wherein the electrical switch is further movable to a fourth position to electrically interconnecting the light source, the power storage device and the first electrical connector.

14. An LED table lamp, comprising:
a light source for emitting light;
a rechargeable battery secured to the light source;
a first electrical connector secured to the light source;
a lamp stand supporting the light source, the lamp stand comprising a second electrical connector configured for electrically connecting with an external power source, the second electrical connector being detachably connected to the first electrical connector; and
an electrical switch to selectively electrically connect the light source to one of the rechargeable battery and the first electrical connector or electrically connect the rechargeable battery to the first electrical connector.

15. The LED table lamp of claim 14, wherein the first electrical connector electrically connects with the second electrical connector when the second electrical connector is connected to the first electrical connector.

16. The LED table lamp of claim 14, further comprising a body, the body interconnecting the light source and the first electrical connector, the body defining a receiving chamber in an end thereof, the rechargeable battery being received in the receiving chamber.

17. The LED table lamp of claim 16, wherein the electrical switch is provided on the body.

18. An LED lamp which is able to be used as a table lamp or an electric torch, the lamp comprising:
a lamp stand configured for electrically connecting an external electrical power supply; and
an LED lighting module detachably mounted to the lamp stand and comprising a light source and a rechargeable battery;
wherein the LED lighting module is powered by the rechargeable battery and acts as the electric torch when the lighting source is electrically connected to the rechargeable battery and the LED lighting module is detached from the lamp stand; and
wherein the LED lighting module and the lamp stand together act as the table lamp when the LED lighting module is mounted on the lamp stand in which the LED lighting module is electrically connected with the lamp stand.

19. The LED lamp of claim 18, wherein the LED lighting module further comprises a switch, the switch is able to be switched among first, second, third and fourth positions, when in the first position, the rechargeable battery is electrically connected to the external electrical power supply to be charged, in the second position, the LED lighting module is electrically connected to the rechargeable battery to be turned on, in the third position, the LED lighting module is electrically connected to the external electrical power supply to be turned on, and in the fourth position, both the LED lighting module and the rechargeable battery are electrically connected to the external electrical power supply.
